(19) United States
(12) Patent Application Publication
(10) Pub. No.: US 2006/0049548 A1
(43) Pub. Date: Mar. 9, 2006

(54) Method for producing an optical or electronic module provided with a plastic package and an optical or electronic module

(76) Inventors: Albert Auburger, Regenstauf (DE); Hans Hurt, Regensburg (DE); Stefan Paulus, Zeitlarn (DE); Nikolaus Schunk, Maxhutte-Haidhof (DE); Frank Weberpals, Regensburg (DE); Josef Wittl, Parsberg (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/216,565

(22) Filed: Aug. 31, 2005

(30) Foreign Application Priority Data
Aug. 31, 2004 (EP) 04 090 336.1

(51) Int. Cl. B29D 11/00; B29C 45/14

(52) U.S. Cl. 264/400; 264/1.7; 264/272.11

(57) ABSTRACT

The invention relates to a method for producing an optical or electronic module provided with a plastic package. The method includes provision of at least one optical or electronic component, the component having an operative region via which it is in operative connection with the surroundings in the finished module, and application to the component of a protective layer which covers at least the operative region of the component. The method further includes encapsulation of the at least one component with at least one polymer compound to form the package, and partial removal of the polymer compound from the outside by a laser ablation device such that the polymer compound between the protective layer of the component and the outer side of the plastic package is removed. The protective layer is, in this case, not transparent with respect to the radiation emitted by the laser ablation device. The invention relates furthermore to an optical or electronic module with at least one optical or electronic component, to which a protective layer is applied.

### REFERENCE TO RELATED APPLICATION

This application claims the benefit of the priority date of European patent application 04 090 336.1, filed on Aug. 31, 2004, the contents of which is herein incorporated by reference in its entirety.

### FIELD OF THE INVENTION

The invention relates to a method for producing an optical or electronic module provided with a plastic package, in which, after the encapsulation of the module components with a polymer compound, a component which was in operative connection with the surroundings is partially exposed again in a subsequent method step. Furthermore, the invention relates to a corresponding optical or electronic module.

### BACKGROUND OF THE INVENTION

It is known to embed optoelectronic modules with a transparent embedding material. For example, DE 199 09 242 A1 discloses an optoelectronic module in the case of which a leadframe with an optoelectronic transducer is positioned in a module package and embedded with a transparent, moldable polymer material. Light is coupled in or out by means of an optical fiber, which is coupled to a connecting piece of the module package. On the leadframe there is also the driver device or receiving device for the optoelectronic transducer.

However, the use of embedding materials that are transparent for the respective range of wavelengths has disadvantages to the extent that transparent embedding materials generally have a high coefficient of thermal expansion and accordingly, when there are great temperature fluctuations, stresses which can damage the sensitive bonding wire connections in particular occur in the package.

It is therefore advantageous in principle to use for embedding or press-molding the components of a module non-transparent polymer materials provided with fillers which produce a favorable coefficient of thermal expansion of the polymer material. A disadvantage of the use of such polymers as an embedding material is that an optical path cannot be created within the embedding material.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention is directed to a method for producing an optical or electronic module provided with a plastic package and also providing an optical or electronic module which make it possible to bring an embedded component of the module into operative connection with the surroundings.

The invention comprises applying a protective layer to the component that at least covers the operative region of the component. The protective layer is, in one embodiment, not transparent with respect to the radiation emitted by the laser ablation device, so that the component is reliably protected from the radiation thereof. In particular, light of the laser ablation device is prevented from being able to penetrate into the component and cause damage thereto.

The polymer compound is removed between the protective layer and the outer side of the plastic package by the laser ablation device. It is therefore envisaged to expose the component that is provided with a protective layer again after the encapsulation with a polymer material, i.e. to remove the covering polymer material again in order that said component can enter into operative connection with the surroundings. The present invention is based on the idea of providing a laser resist layer which prevents damage to the component due to laser light which is emitted by the laser ablation device for the formation of an opening in the polymer compound.

The application of the protective layer may be accomplished for example by a standard wafer process before singulation of the components or on the individual component, for instance with the aid of a dosing operation.

The optical or electronic module according to the invention comprises a protective layer which is applied to the optical or electronic component and covers at least the operative region of the component. The protective layer is, in one embodiment, formed so as to be reflective for radiations of the wavelength with which a laser ablation device has formed a laser-ablated opening in the plastic package for the purpose of exposing the operative region of the component. The protective layer remains on the component even after the laser-ablated opening has been made in the plastic package, in one example.

It is pointed out that the method according to the invention comprises both configurations in which the protective layer remains on the component after formation of the laser-ablated opening and configurations in which the protective layer is removed again by a suitable process, for example chemically, after formation of the laser-ablated opening. In the latter case, the protective layer is no longer included in the finished module.

The protective layer may have different geometries. In one exemplary configuration, the protective layer is formed as a planar layer. The protective layer may, however, also be provided for example by a drop, which is applied to the operative region of the component and then hardened.

In one exemplary configuration, the protective layer is formed as a system of layers, for example as a system of layers with at least one metal layer or at least one plastic layer.

An operative region of the optical or electrical component refers in one example to any region that permits an operative connection of the component to the surroundings. For example, it is the photosensitive region of a photodiode, the sensor region of a pressure sensor or a temperature sensor, the light-emitting region of a semiconductor laser or an LED or the area of a lens, a mirror or a prism that is facing the outer side of the module.

In one embodiment, the component is an optical component which emits or detects light of a specific wavelength via the operative region. In this case, the protective layer is transparent for light of the wavelength emitted or detected, but not for the radiation of the laser ablation device. In order to achieve this, the protective layer is, for example, formed as an interference filter.

In one exemplary configuration, the optical or electronic component is electrically contacted by electrical connections, in particular by means of bonding wires, before the encapsulation with plastic. In this example, the electrical connections lie in a region of the polymer compound in which partial removal of the polymer compound does not take place. The bonding wires therefore are not be damaged during the exposure of the component.

The optical or electronic component is arranged on a carrier before the encapsulation in one example. The carrier of the module preferably takes the form of a leadframe, also referred to as a metal carrier or a stamped grid. The leadframe has in this example at least one planar carrier region, also referred to as a “die pad” or “chip island”, and also a plurality of contact leads, which are located at the edge region of the leadframe. The optical or electronic component is in this case respectively arranged on a carrier region.

Instead of a leadframe, however, it is also possible in principle for any other carriers to be used, for example carriers which comprise a patterned film of plastic or a printed circuit board. It is also possible in principle to dispense with a separate carrier entirely.

The optical component in one embodiment comprises an optoelectronic transmitting component or an optoelectronic receiving component, in particular a photodiode or an LED or a semiconductor laser. If the component is an electronic component, it comprises a sensor in one example, in particular a pressure sensor or a temperature sensor.

The act of encapsulating with a polymer compound comprises in one example embedding or press-molding the component with the polymer compound. The embedding or press-molding may in this case take place in a special mold, in particular an injection mold.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention is explained in more detail below on the basis of an exemplary embodiment with reference to the figures, in which:

FIG. 1 is a sectional view illustrating an optical module with an optical component during the production of the module and after embedding of the module with a polymer compound; and

FIG. 2 is a sectional view illustrating the finished optical module, produced by the method of the present invention.

### DETAILED DESCRIPTION OF THE INVENTION

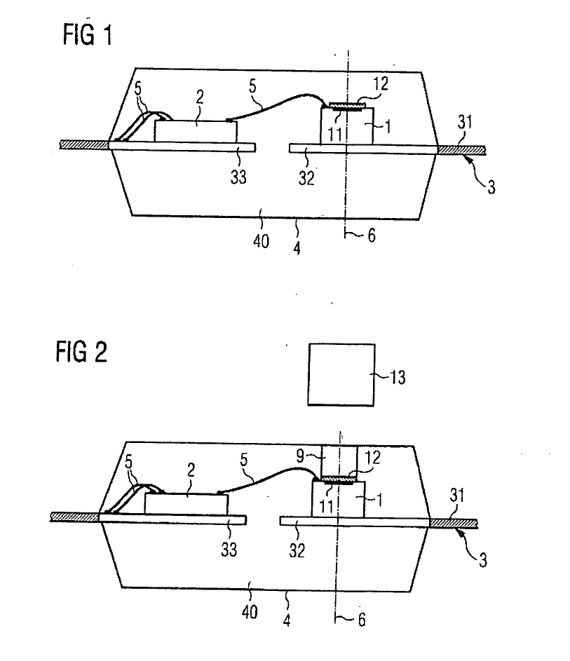

FIG. 1 shows an optical module with an optical component 1 and an assigned electronic device 2, which are arranged on a leadframe 3 and embedded with a non-transparent polymer compound 40, which provides a plastic package 4.

The optical component 1 is, for example, a luminescence diode (LED), a semiconductor laser or a photodiode. The electronic device 2 is, for example, a driver or a preamplifier. The optical component 1 preferably takes the form of a prefabricated chip, and the electronic device 2 preferably takes the form of an integrated circuit (IC), in one example.

The leadframe 3 has two planar carrier areas 32, 33, which are also referred to as “die pads” and on which on the one hand the optical component 1 and on the other hand the electronic device 2 are arranged. Furthermore, the leadframe 3 has at its edge a plurality of contact leads 31. In this case, the contact leads project from the embedding compound 4. Leadframes 3 of this type are known in the prior art, so are not discussed any further.

Arranged on the two carrier areas 32, 33 are the optical component 1 and the electronic device 2. Electrical contacting of these module components 1, 2 takes place on the one hand by a contact on the underside, which is electrically connected directly to the respective carrier area 32, 33, and on the other hand by means of bonding wires 5.

The optical component 1 has on its upper side an operative region 11. This is, for example, a light-emitting area 11 of an LED chip.

To provide a favorable coefficient of thermal expansion, the polymer compound 40 is provided with a filler and is therefore not transparent for the light emitted or received. The optical path of the optical component 1 is closed.

It is therefore envisaged to produce an opening 9 in the polymer compound 40 in a further method step, so that the operative region 11 of the optical component 1 is exposed and the optical component 1 can enter into operative connection with the surroundings. The correspondingly completed module is represented in FIG. 2.

For the formation of an opening 9 in the polymer compound 40, it is envisaged to use a laser ablation device 13, which is represented in FIG. 2 as a functional block. In a configuration given by way of example, the laser ablation device 13 comprises a laser, for example an Nd:YAG laser, which emits light of a wavelength of 1064 nm, and also a mirror drum assigned to the laser. The laser is in this example arranged such that the beam emitted by the laser falls on the rotating mirror drum. The mirror drum has a polygonal cross section, so that when the mirror drum rotates about a horizontal longitudinal axis the laser beam is deflected in a limited laser beam region, the opening 9 being formed in the non-transparent polymer compound 40. Suitable mirror surfaces of the mirror drum achieve the effect that the laser beam extends over a surface area on the polymer compound, so that a three-dimensional laser-ablated opening is dug into the plastic package 4.

Depending on the exact configuration of the laser ablation device, the opening 9 may in this case have different configurations. Generally, the laser-ablated opening 9, which is merely schematically represented in FIG. 2, will be formed in a funnel-shaped manner.

The formation of an opening 9 in the plastic package using a laser ablation device has the advantage that an opening can be produced in the polymer compound 40 with high precision.

However, when the laser is used for the formation of the opening 9 in the package 4, there is the risk of the component 1 being damaged by the laser beam itself or on account of high temperatures resulting from the ablation of the plastic compound by means of the laser beam. In particular, the laser light of the laser ablation device must be prevented from penetrating into the optical component 1 or its operative region 11 and causing damage.

To prevent such damage, it is envisaged to provide a protective layer 12 on the area of the component 1 that is facing the exterior of the package. The protective layer 12 in this example covers at least the operative region 11 of the component 1.

There are a number of configurational variants concerning the way in which the protective layer 12 is provided and the form it takes.

In a first configurational embodiment of the invention, the protective layer is formed as a reflective layer 12, which reflects light of the wavelength which the laser ablation device 13 emits. This has the result that, after ablation of the polymer material that is formed between the reflective layer 12 and the outer side of the plastic package 4, the operation of exposing the optical component 1 is automatically ended. Further ablation is prevented by the reflective layer 12. In this case, it may additionally be provided that the laser ablation device 13 monitors whether it detects a reflected signal, and if this is the case ends the laser ablation. The light reflected at the reflective layer 12 is consequently used in such embodiment for generating a control signal concerning the control of the laser ablation.

However, in the example when the protective layer 12 takes the form of a reflective layer it is necessary—in any event if the component 1 takes the form of an optoelectronic component—that, although the reflective layer 12 reflects the light generated by the laser ablation device 13, it is transparent with respect to the light emitted or to be detected by the component 1. For this purpose, the reflective layer 12 is formed as an interference filter, which is transparent for the light emitted by the component 1 or the light to be detected by the component 1, but reflects other wavelengths. Such an interference filter may be formed as a system of layers comprising plastic layers or metal layers in a way known per se.

If the component 1 is, for example, a photodiode which detects light of a specific wavelength of, for example, 650 nm, 850 nm, 1310 nm or 1550 nm, an interference filter which is transparent for the corresponding detection wavelength is used as the protective layer 12. On the other hand, the interference filter is not transparent and is highly reflective for the light emitted by the laser ablation device 13 (which, in the case of an Nd:YAG laser that is used for example, has a wavelength of 1064 nm). This ensures that the component 1 to be exposed is not damaged by the light of the laser ablation device 13.

In another exemplary embodiment of the invention, the component 1 is an LED or a semiconductor laser, and the reflective layer 12 has a construction such that, although the light of the laser ablation device 13 is reflected, at the same time the light of the laser or of the LED passing through the reflective layer 12 in the opposite direction is allowed through.

In both cases, it is necessary that the wavelength of the laser ablation device and the wavelength of the detected or emitted light are sufficiently different to ensure the separation of the transmission properties.

In the case of the formation of the protective layer 12 as a reflective layer, it is possible that the reflective layer remains on the optical component 1 after formation of the opening 9 in the plastic package 4 and after the accompanying exposure of the optical component. This avoids an additional method step of removing the protective layer 12. Also, the protective layer remaining on the component 1 can contribute to protecting the component 1 and its operative area 11 from external influences such as dirt and dust.

In another configurational embodiment of the invention, as a departure from this it is provided that, although the protective layer 12 is formed as a reflective layer, it is removed after forming the opening 9, for example by means of an etching liquid, an etching gas or some other suitable method. For this case, it is not necessary that the reflective layer be transparent for the light of the wavelength emitted or to be detected, since the protective layer 12 is no longer present during the subsequent operation of the module.

In yet another configurational embodiment of the invention, the protective layer 12 (which may also be referred to as a laser resist layer) is not formed as a reflective layer. It is, in this example, a layer of a material which has a lower laser ablation rate in comparison with the polymer compound 40. Consequently, if the laser beam of the laser ablation device 13 penetrates into the region of the protective layer 12, an ablation of the protective layer 12 takes place at a distinctly reduced rate. Even in the case where the ablation of the polymer material 40 by means of the laser ablation device 13 is provided with a certain tolerance and the depth of ablation cannot be set with extreme accuracy, it is prevented in this way that the radiation of the laser ablation device 13 can fall on the component 1 or its operative region 11 and thereby damage it. The protective layer 12 is in this example formed so as to be non-transparent. In the case of this configurational variant, after the formation of the laser-ablated opening 9 in the plastic package 4, the protective layer is removed again. As already mentioned, this takes place for example by means of an etching liquid or an etching gas.

The use of a protective layer 12 makes it possible also to use for the realization of a laser ablation in the plastic layer 40 methods that operate relatively simply and with relatively low precision, since damage to the component 1 is reliably prevented by the protective layer 12. The methods and corresponding laser ablation devices 13 can therefore be formed or configured in a low-cost manner.

It is pointed out that, in principle, after its formation, the opening 9 can be at least partially filled again with a filling material with desired properties, for example a transparent material. Such a transparent material may be provided for example for the purpose of its additional sealing of the component 1 with respect to the surroundings.

It is also pointed out that the component 1 may also be an electronic component. For example, the component 1 may be a sensor chip, in particular a pressure sensor or a temperature sensor, as are used in the automobile industry. In the event that the component 1 is a pressure sensor, the filling material mentioned preferably takes an elastomeric form, so that it can pass on pressures occurring to the component 1 without thereby falsifying the pressure measurement.

Furthermore, it is pointed out that the module may have a number of optical or electronic components of the type described, an additional protective layer 12 then being provided for each of the components.

The production of the optical or electronic module takes place, in one example, as repeats on a multi-cavity mold, the individual optical or electronic modules being singulated after curing of the polymer material and exposure of the respective components.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method of producing an optical or electronic module provided with a package, comprising:
providing at least one optical or electronic component, the component comprising an operative region, via which the component is in operative connection with the surroundings in the finished package;
applying to the component a protective layer that covers at least the operative region thereof;
encapsulating the at least one component with at least one polymer compound to form the package; and
removing a portion of the polymer compound by radiation emitted by a laser ablation device such that the polymer compound between the protective layer of the component and an outer side of the package is removed,
wherein the protective layer is not transparent with respect to the radiation emitted by the laser ablation device.

2. The method of claim 1, wherein the protective layer comprises a lower laser ablation rate in comparison with a laser ablation rate of the polymer compound of the package.

3. The method of claim 1, wherein the protective layer reflects the radiation emitted by the laser ablation device.

4. The method of claim 1, further comprising, after the partial removal of the polymer compound, removing the protective layer from the component.

5. The method of claim 1, wherein after the partial removal of the polymer compound, the protective layer remains on the operative region of the component.

6. The method of claim 3, wherein the component comprises an optical component that emits or detects light of a specific wavelength via the operative region, and wherein the protective layer is transparent with respect to light of the specific wavelength.

7. The method of claim 6, wherein the component comprises an optoelectronic transmitting component, and wherein the protective layer is transparent with respect to light of the wavelength emitted, and reflective with respect to radiation emitted by the laser ablation device.

8. The method of claim 6, wherein the component comprises an optoelectronic receiving component, and wherein the protective layer is transparent with respect to light of the wavelength to be detected, and reflective with respect to radiation emitted by the laser ablation device.

9. The method of claim 6, wherein the specific wavelength emitted or detected lies in the range of about 650 nm to about 1550 nm.

10. The method of claim 6, wherein the radiation emitted by the laser ablation device comprises a wavelength of about 1064 nm.

11. The method of claim 3, further comprising:
detecting the radiation reflected by the protective layer; and
ending removal of the polymer compound by the laser ablation device based on the detected radiation.

12. The method of claim 1, wherein the protective layer is applied to a wafer containing a plurality of optical or electronic components before the wafer is singulated.

13. The method of claim 1, wherein the protective layer is applied to a prefabricated individual component.

14. The method of claim 1, wherein the protective layer comprises a system of layers that form an interference filter.

15. The method of claim 1, wherein the protective layer comprises at least one metal layer or at least one plastic layer.

16. The method of claim 1, wherein the optical or electronic component is arranged on a carrier before the encapsulation.

17. The method of claim 16, wherein the carrier comprises a leadframe comprising at least one planar carrier region and a plurality of contact leads located at the edge region of the leadframe, and wherein the optical or electronic component is arranged on a carrier region thereof.

18. The method of claim 1, wherein the electronic component comprises a pressure sensor or a temperature sensor.

19. The method of claim 1, wherein encapsulating comprises embedding or press-molding the at least one component with the polymer material.

20. An optical or electronic module, comprising:
at least one optical or electronic component comprising an operative region, via which the component is in operative connection with the surroundings thereof;
a protective layer covering at least the operative region of the component; and
a package in which the component is arranged,
wherein the package comprises, adjacent the protective layer, a laser-ablated opening, wherein the operative region of the component is in operative connection with the surroundings via the laser-ablated opening, and
wherein the protective layer is reflective with respect to radiation of the wavelength with which a laser ablation device is employed to form the laser-ablated opening in the package.

21. The module of claim 20, wherein the component is an optical component that emits or detects light of a specific wavelength via the operative region, and wherein the protective layer is transparent with respect to light of the specific wavelength emitted or detected.

22. The module of claim 20, wherein the protective layer comprises a plurality of layers that form an interference filter.

23. The module of claim 20, wherein the protective layer comprises at least one metal layer or at least one plastic layer.
